(19) United States
(12) Patent Application Publication
(10) Pub. No.: US 2002/0090947 A1
(43) Pub. Date: Jul. 11, 2002

(54) Automatic reconnect of dropped calls

(76) Inventors: Frank Brooks, Vista, CA (US); Kurt Bantle, Carlsbad, CA (US)

Correspondence Address: SCOTT C. HARRIS, Fish & Richardson P.C., Suite 500, 4350 La Jolla Village Drive, San Diego, CA, 92122, US

(21) Appl. No.: 10/032,152

(22) Filed: Dec. 20, 2001

Related U.S. Application Data
(60) Provisional application No. 60/257,925, filed on Dec. 22, 2000.

(51) Int. Cl. H04Q 7/20

(52) U.S. Cl. 455/436; 455/450; 455/567

(57) ABSTRACT

A wireless communication system automatically attempts to reconnect when a dropped call is detected. A call may be originated by the mobile station or as the result of a base station page. When a call is originated by the mobile station, the mobile station will attempt to reconnect the call when an interruption of service is detected. When the call is the result of a base station page, the base station will attempt to re-page the mobile station after an interruption of service. Audio indicators may be played to the users indicating that service was interrupted and a reconnection attempt is in progress.

### CROSS-REFERENCE TO RELATED APPLICATIONS

This application claims benefit of U.S. Provisional application No. 60/257,925, filed Dec. 22, 2000, the content of which is herein incorporated by reference in its entirety.

### TECHNICAL FIELD

This invention relates to wireless communication systems, and more particularly to enable reacquisition of dropped call through the wireless communication system.

### BACKGROUND

Cellular telephones may operate under a variety of standards including the code division multiple access (CDMA) cellular telephone communication system as described in TIA/EIA, IS-95, Mobile station-Base Station Compatibility Standard for Dual-Mode Wideband Spread Spectrum Cellular System, published July 1993. CDMA is a technique for spread-spectrum multiple-access digital communications that creates channels through the use of unique code sequences. In CDMA systems, signals can be and are received in the presence of high levels of interference. The practical limit of signal reception depends on the RF channel conditions. Typically, the system operates with a lower level of interference and dynamic channel conditions.

In current CDMA systems, mobile stations acquire the pilot signal of a base station. The pilot signal has identifying spreading code used by the mobile station. The mobile stations use the pilot signal to synchronize themselves with the base station so the mobile stations can recognize any of the other channels necessary. Once a mobile station acquires the pilot signal of a base station, the mobile station may communicate with the base station over the appropriate channels of the wireless communication system.

During a call, a mobile station occasionally loses communication with the base station, causing the call to be dropped. This creates frustration for a user as a call is disconnected in the middle of a conversation. Dropped calls are typically the result of a momentary interruption of the wireless service. The service is often reacquired immediately after the interruption. When a call is dropped, the user must realize the call has been dropped, and then reinitiate the call to continue the conversation.

What is needed is a system that automatically attempts to reconnect a dropped call to allow the user to continue the conversation with minimal interruption.

### SUMMARY

The present invention automatically attempts to reconnect a dropped call in a wireless communication system. A call may be originated by the mobile station or as the result of a base station page. When a call is originated by the mobile station, the mobile station will attempt to reconnect the call when an interruption of service is detected. When the call is the result of a base station page, the base station will attempt to re-page the mobile station after an interruption of service. Audio indicators may be played to the users indicating that service was interrupted and a reconnection attempt is in progress.

### DESCRIPTION OF DRAWINGS

These and other features and advantages of the invention will become more apparent upon reading the following detailed description and upon reference to the accompanying drawings.

FIG. 1 illustrates the components of an exemplary wireless communication system used by one embodiment of the present invention.

FIG. 2 is a block diagram showing features of a mobile station according to one embodiment of the invention.

FIG. 3 is a flowchart illustrating the reacquisition process according to one embodiment of the present invention.

### DETAILED DESCRIPTION

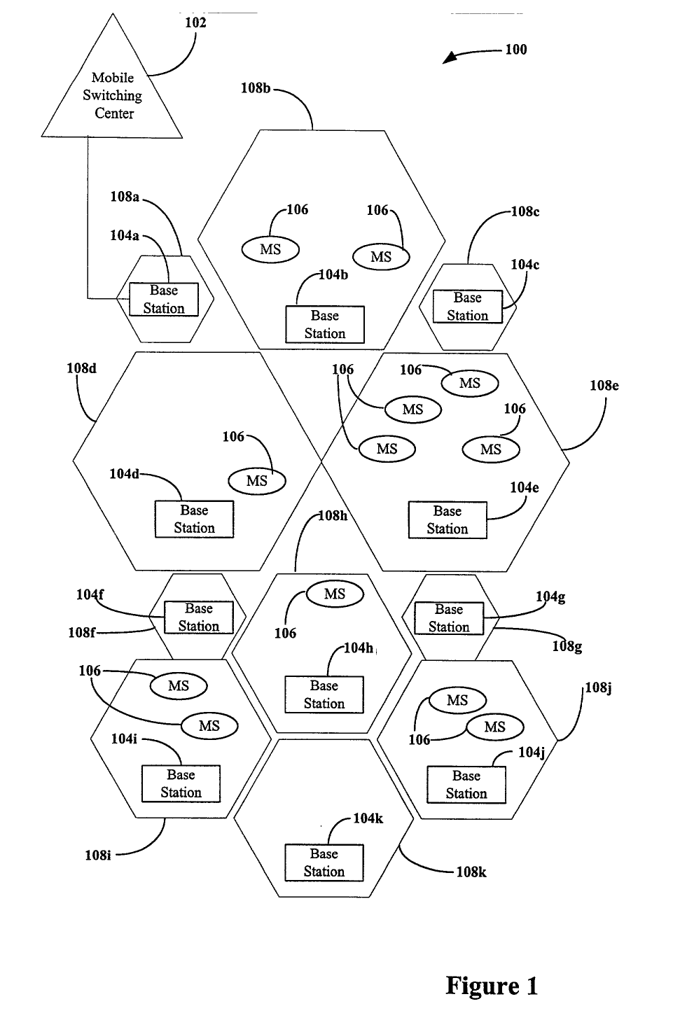

FIG. 1 illustrates components of an exemplary wireless communication system. A mobile switching center 102 communicates with base stations 104a-104k (only one connection shown). The base stations 104a-104k (generally 104) broadcasts data to and receives data from mobile stations 106 within cells 108a-108k (generally 108). The cell 108 is a geographic region, roughly hexagonal, having a radius of up to 35 kilometers or possibly more.

A mobile station 106 is capable of receiving data from and transmitting data to a base station 104. In one embodiment, the mobile station 106 receives and transmits data according to the Code Division Multiple Access (CDMA) standard. CDMA is a communication standard permitting mobile users of wireless communication devices to exchange data over a telephone system wherein radio signals carry data to and from the wireless devices.

Under the CDMA standard, additional cells 108a, 108c, 108d, and 108e adjacent to the cell 108b permit mobile stations 106 to cross cell boundaries without interrupting communications. This is so because base stations 104a, 104c, 104d, and 104e in adjacent cells assume the task of transmitting and receiving data for the mobile stations 106. The mobile switching center 102 coordinates all communication to and from mobile stations 106 in a multi-cell region. Thus, the mobile switching center 102 may communicate with many base stations 104.

Mobile stations 106 may move about freely within the cell 108 while communicating either voice or data. Mobile stations 106 not in active communication with other telephone system users may, nevertheless, scan base station 104 transmissions in the cell 108 to detect any telephone calls or paging messages directed to the mobile station 106.

One example of such a mobile station 106 is a cellular telephone used by a pedestrian who, expecting a telephone call, powers on the cellular telephone while walking in the cell 108. The cellular telephone scans certain frequencies (frequencies known to be used by CDMA) to synchronize communication with the base station 104. The cellular telephone then registers with the mobile switching center 102 to make itself known as an active user within the CDMA network.

When detecting a call, the cellular telephone scans data frames broadcast by the base station 104 to detect any telephone calls or paging messages directed to the cellular telephone. In this call detection mode, the cellular telephone receives, stores and examines paging message data, and determines whether the data contains a mobile station identifier matching an identifier of the cellular telephone. If a match is detected, the cellular telephone establishes a call with the mobile switching center 102 via the base station 104. If no match is detected, the cellular telephone enters an idle state for a predetermined period of time, then exits the idle state to receive another transmission of paging message data.

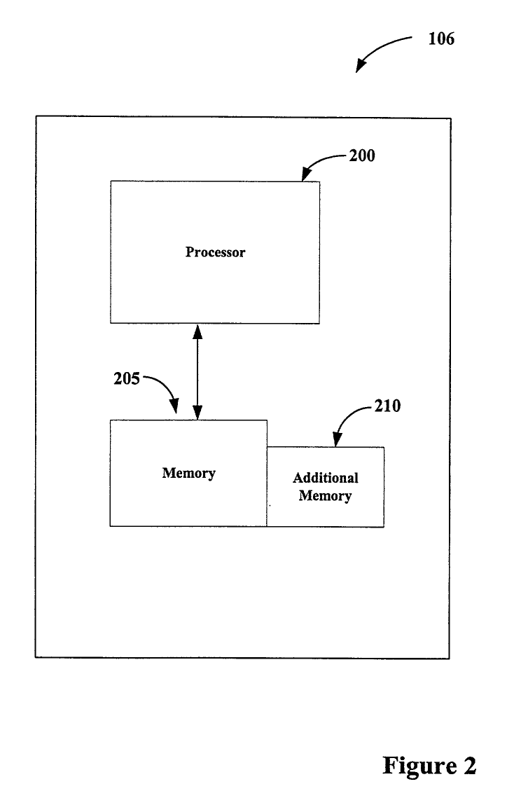

FIG. 2 shows a block diagram of the mobile station 106 and the processing that occurs in that mobile station 106. The processor 200 is driven by a program stored in a memory 205. Other data, such a voice recordings for the mobile station 106 may also be stored in another part of memory shown here as 210. The memory 210 may store various items including voice messages and user data.

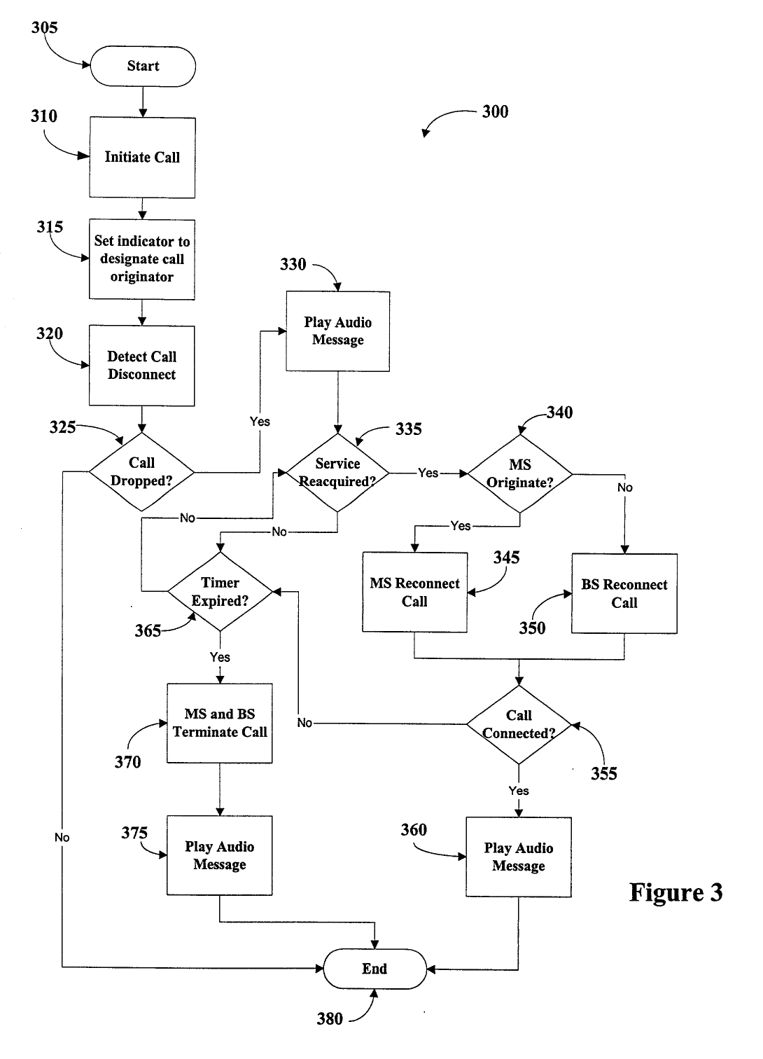

The wireless communication system executes a process 300 shown in FIG. 3. The process 300 begins at a START state 305. Proceeding to state 310, the wireless communication system initiates a call between the mobile station 106 and a base station 104. The call can either be initiated by the mobile station 106 or by the base station 104. For outgoing calls, the mobile station 104 may communicate with the base station 104 over the appropriate channels of the wireless communication system requesting a connection. The telephone number requested by the mobile station 104 may then be dialed and connected. For incoming calls, the base station 104 may send a paging message to the mobile station 106 indicating an incoming call and setting up a connection.

Proceeding to block 315, an indicator may be set to designate the call originator. The indicator should be set in both the mobile station 106 and the base station 104. The indicator will enable the wireless communication system to later determine the origin of the call to assist in reconnection. The indicator may simply be a flag, with the flag set to a “1” value if the mobile station 106 originated the call and the flag set to a “0” if the base station 104 originated the call. Of course, any other indicator may be used as is known in the art without departing from the spirit of the invention. Also the ESN and MIN of the Handset can be stored at the MSC and linked with the flag.

Proceeding to block 320, the wireless communication system monitors the call to detect a call disconnect. Both the mobile station 104 and the base station 106 may monitor the call to determine a call disconnect. If the call was intentionally disconnected, such as by either party ending the call and hanging up, a release order is typically sent. For example, if the mobile station 106 hangs up, the mobile station 106 sends a release order to the base station 104, and the base station 104 responds with a release order. If the far end hangs up, the base station 104 sends a release order to the mobile station 106, and the mobile station 106 responds with a release order. Thus, the presence of a release order indicates the call was properly terminated. However, both the base station 104 and the mobile station 106 can determine that a call was likely dropped.

Proceeding to block 325, the process 300 determines whether the call was dropped. A flag may be set to indicate whether the call was released normally or whether the call was dropped. The mobile station 106 detects a dropped call due to the loss of the active pilots when the received power from the active pilots degrades below a usable level. Under theses circumstances, the mobile station 106 indicates a system loss determination and exits the CDMA conversation state to the system selection with a loss of service indication. The mobile station may also detect a dropped call due to the loss of the forward traffic channel. When the mobile station 106 is unable to receive a usable forward traffic channel for a period of time (typically 5 seconds), the mobile station 106 terminates the reverse link transmission and exits the CDMA conversation state to system selection with a loss of service indication. The mobile station 106 may also detect a dropped call due to a N1m timeout, which is the maximum number of attempts a mobile station 106 will make to transmit a message. If the reverse link is corrupted at the same time the mobile station 106 attempts to send a message that requires an acknowledgement (i.e., pilot strength measurement message), the mobile station 106 will attempt to resend the message a set number of times (typically 9). If an acknowledgement is not received from the base station 104, the mobile station 106 ends reverse link transmission and exits the CDMA conversation state for system selection with a loss of service indication.

The base station 104 detects a dropped call by the loss of the reverse traffic channel. If the base station 104 does not receive usable reverse traffic channel frames for a period of time (Base station vendors are allowed to determine the value of this timer, typically 5 seconds), the base station 104 typically ends transmission on the forward traffic channel. The base station 104 may also detect a dropped call if the mobile station 106 is not acknowledging a message requiring acknowledgement.

If the call was not dropped, a release order is typically detected and the process 300 proceeds along the NO branch to and END block 380, where the process 300 terminates because the call was properly terminated. Returning to block 325, if a dropped call was detected, the process 300 proceeds along the YES branch to block 330, where an optional audio message may be played to both participants of the phone call. The message may indicate to the participants that the call has been dropped, but a reconnection is being attempted. An example of such a message may be “Audio link has been disabled, please hold while we attempt to re-establish the link.”

Proceeding to block 335, the process 300 determines if the wireless service has been reacquired. The wireless service needs to be available before the call can be reconnected. If the service is not available, the process 300 proceeds along the NO branch to block 365. In block 365, the process 300 checks to see if a timer has expired indicating that attempts to reconnect the call should be terminated. The timer may be preset to a value, or may be dynamically adjusted as circumstances warrant.

Returning to block 335, if the service is reacquired, the process 300 proceeds along the YES branch to block 340. In block 340, the process 300 determines if the mobile station 106 originated the call, or if the call was originated by the base station. This determination may be made by checking the indicator designating the call origin. If the indicator determines that the mobile station 106 originated the call, the process 300 proceeds along the YES branch to block 345 where the mobile station 106 attempts to reconnect the call with any service available. If the timer has not expired the MSC can recognized the origination message as a reconnect attempt based on the timer having not yet expired for the previously stored ESN and MIN. If the indicator determines that the base station 104 originated the call, the process 300 proceeds along the NO branch to block 350 where the base station 104 attempts to reconnect the call, the page can be sent from the original cell and any cell sites adjacent to the original. The call originator should be the one to reconnect, as only the call originator may know the proper phone numbers.

After either the mobile station 106 or the base station 104 attempts to reconnect the call, the process 300 proceeds to block 355 to determine if the call has been reconnected. If the call is not reconnected, the process 300 proceeds along the NO branch back to block 365 to check to see if the timer has expired. If the timer has not expired, the process 300 will again check that service is present and reattempt to connect the call.

Returning to block 355, if the call if successfully reconnected, the process 300 proceeds along the YES branch to block 360. In block 360, the process 300 provides an indication such as an audio message that the call is reconnected. The audio message may indicate that the connection is reestablished and the conversation may be continued. The audio message may be played to both parties of the call. After successfully reconnecting the call and notifying the parties, the process 300 terminates in END block 380.

Returning to block 365, if the timer expires prior to service being acquired or the call being reconnected, the process 300 proceeds along a YES branch to block 370. In block 370, both the mobile station 106 and the base station 104 terminate the call. The call may be terminated by sending a release order. To have both the mobile station 106 and the base station 104 determine the timer has expired, the timer should be kept by both the mobile station 106 and the base station 104.

Proceeding to block 375, after the call is terminated, the process 300 may provide an indication to the parties that the attempt to reconnect the call failed. The indication may be an audio message such as “We're sorry, the attempt to reestablish the call was unsuccessful, please try your call again.” This allows the parties to know that the call will not be reconnected. After the parties are notified, the process 300 terminates in the END block 380.

To support the invention, the overhead messaging of the paging channel or a new message may be added indicating whether the base station 104 is set to support the automatic reconnect attempts. For example, a field may be included in a message indicating the reconnect capabilities of the base station, where a “1” indicates the base station 104 supports automatic reconnect and a “0” indicates the base station 104 does not support automatic reconnection. The base station 104 may also be modified such that a hook flash is not sent to the PSTN to terminate the call until after the timer has expired and the reconnection attempts cease.

Numerous variations and modifications of the invention will become readily apparent to those skilled in the art. Accordingly, the invention may be embodied in other specific forms without departing from its spirit or essential characteristics.

What is claimed is:

1. A method of automatically reconnecting a dropped call in a wireless communication system comprising:
detecting a call disconnection;
determining the call disconnection was unintentional; and
reconnecting the call.

2. The method of claim 1, further comprising determining a call originator.

3. The method of claim 2, further comprising attempting reconnection by the call originator.

4. The method of claim 1, further comprising;
starting a timer upon detecting the call disconnection; and
terminating the call upon expiration of the timer.

5. The method of claim 4, further comprising providing an indicator the call was terminated.

6. The method of claim 1, further comprising providing an indicator the call was dropped.

7. The method of claim 1, further comprising providing an indicator the call is reconnected.

8. A method of reconnecting dropped calls in a wireless communication system comprising:
determining a call originator;
detecting a dropped call;
detecting if service if available;
attempting reconnection by the call originator if the service is available; and
terminating the call if not reconnected within a predetermined period of time.

9. The method of claim 8, further comprising notifying call parties the call was dropped.

10. The method of claim 8, further comprising notifying call parties the call is reconnected.

11. The method of claim 8, further comprising notifying call parties the call is terminated.

12. The method of claim 8, determining the call was dropped by loss of an active pilot.

13. The method of claim 8, determining the call was dropped by loss of a forward traffic channel.

14. The method of claim 8, determining the call was dropped by loss of a reverse traffic channel.

15. The method of claim 8, determining the call was dropped by lack of message acknowledgement.

16. A wireless communication system comprising:
a base station; and
a mobile station which initiates a call with the base station, wherein the mobile station determines the call becomes disconnected and attempts to automatically reconnect the call within a predetermined period of time, and wherein the mobile station and the base station terminates the call if not reconnected within the predetermined period of time.

17. The wireless communication system of claim 16, wherein the mobile station and the base station provide an indication the call was dropped.

18. The wireless communication system of claim 16, wherein the mobile station and the base station provide an indication the call is reconnected.

19. The wireless communication system of claim 16, wherein the mobile station and the base station provide an indication the call is terminated.

20. The wireless communication system of claim 16, wherein the mobile station determines the call was dropped by loss of an active pilot.

21. The wireless communication system of claim 16, wherein the mobile station determines the call was dropped by loss of a forward traffic channel.

22. The wireless communication system of claim 16, wherein the mobile station determines the call was dropped by lack of message acknowledgement.

23. A wireless communication system comprising:
a mobile station; and
a base station which initiates a call with the mobile station, wherein the base station determines the call becomes disconnected and attempts to automatically reconnect the call within a predetermined period of time, and wherein the mobile station and the base station terminate the call if not reconnected within the predetermined period of time.

24. The wireless communication system of claim 23, wherein the mobile station and the base station provide an indication the call was dropped.

25. The wireless communication system of claim 23, wherein the mobile station and the base station provide an indication the call is reconnected.

26. The wireless communication system of claim 23, wherein the mobile station and the base station provide an indication the call is terminated.

27. The wireless communication system of claim 23, wherein the base station determines the call was dropped by loss of a reverse traffic channel.

28. The wireless communication system of claim 23, wherein the base station determines the call was dropped by lack of message acknowledgement.
